(19) United States
(12) Patent Application Publication
(10) Pub. No.: US 2003/0072605 A1
(43) Pub. Date: Apr. 17, 2003

(54) Novel planning tool

(76) Inventors: Jim Somerset, Mt. Pleasant, SC (US); Patrick Fitzsimmons, Mt. Pleasant, SC (US)

Correspondence Address: BROWN & MICHAELS, PC, 400 M & T BANK BUILDING, 118 NORTH TIOGA ST, ITHACA, NY, 14850, US

(21) Appl. No.: 10/077,539

(22) Filed: Feb. 15, 2002

Related U.S. Application Data
(60) Provisional application No. 60/269,614, filed on Feb. 16, 2001.

(51) Int. Cl. B42F 13/00

(52) U.S. Cl. 402/73

(57) ABSTRACT

A planner tool comprising multiple pouch pages, lead cards, and printed calendar sheets. Each pouch page and calendar sheet has holes that are appropriately spaced apart so that each of the pages can be placed in a binder. The lead cards have two sets of times of the day and a blank center which are used in conjunction with the printed calendar sheets to make appointments to call, appointments to see others, and keep information regarding the nature of such appointments all in one place. The lead cards are placed in the pouches of the pages. The printed calendar sheets of the planner have the days of the week printed on them with specific columns under each day. The columns have the headings c, m, a, and e, which stand for call, mileage, appointment, and expenses respectively.

### REFERENCE TO RELATED APPLICATIONS

This application claims an invention, which was disclosed in Provisional Application No. 60/269,614, filed Feb. 16, 2001, entitled “NOVEL PLANNING TOOL”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of planning tools. More particularly, the invention pertains to a planning tool that allows information to be modified with regard to date and time without rewriting the information.

2. Description of Related Art

Business associates, salespeople and people who require making a lot of appointments, and scheduling deadlines are all dependent on the need to manipulate and organize information. Disorganization of information in any business or trade can lead the most capable people toward disastrous results. In order to successfully compete and prosper in the business and trade world it is vital to have an organizational tool which will allow you to operate in an efficient, timely, and productive manner.

No planner or organizer currently exists, which enables the user to manipulate information through out time, without rewriting it. Consequently, because a planner or organizer did not exist that eliminated the necessity of rewriting material; numerous leads, prospects, and vital information has been forgotten, misfiled or lost in the shuffle of paperwork and/or cyberspace.

A number of organizers and planners are available to assist the public in the organization of information in both computer software programs and hardcopy versions. Computer software programs are unable to eliminate the redundancy and disorganization of information, nor can they give or guarantee instant access and the physical convenience of having a hard handwritten copy of future plans. Hardcopy versions of planners/organizers are also unable to eliminate the redundancy, disorganization of information, and having the need to rewrite information.

### SUMMARY OF THE INVENTION

A planner tool comprising multiple pouch pages, lead cards, printed calendar sheets, a set of cards with the months of the year printed on them, and a set of four color-coded cards.

Each pouch page has holes that are appropriately spaced apart so that each of the pages can be placed in a binder. The pages also contain at least one pouch for holding different types of cards, such as lead cards or cards with the months printed at the top. The pages also contain a cavity in the center of the pouch page, which is sealed by a zip closure. This cavity is used to store lead cards, cards with the months printed on them, and the color-coded cards.

The planner tool also has a large number of lead cards. Lead cards have two sets of times of the day and a blank center which are used in conjunction with the printed calendar sheets to make appointments to call, appointments to see others, and keep information regarding the nature of such appointments all in one place. The lead cards are placed in the pouches of the various pages.

The printed calendar sheets of the planner have the days of the week printed on them with specific columns under each day. The columns have the headings c, m, a, and e, which stand for call, mileage, appointment, and expenses respectively. In terms of dates on the calendar pages, the option as to whether the user wants to have the date already printed on the sheets or whether the user wants to take the time and fill them in himself is available. Furthermore, each calendar page has holes that are appropriately spaced apart to allow the pages to be put into a binder with the pouch pages.

### BRIEF DESCRIPTION OF THE DRAWING

FIG. 1 shows a standard pouch page.

FIG. 2 shows a business card holder.

FIG. 3 shows a lead card being stored in a small two-sided pouch page.

FIG. 4 (a & b) show the printed calendar sheets.

FIG. 5 shows a set of cards with the printed name of the months of the year being stored in a small two-sided pouch page.

FIG. 6 (a & b) shows the first pouch page.

FIG. 7 (a & b) shows the second pouch page.

FIG. 8 (a & b) shows a representative of one of the four weekly pouch pages.

### DETAILED DESCRIPTION OF THE INVENTION

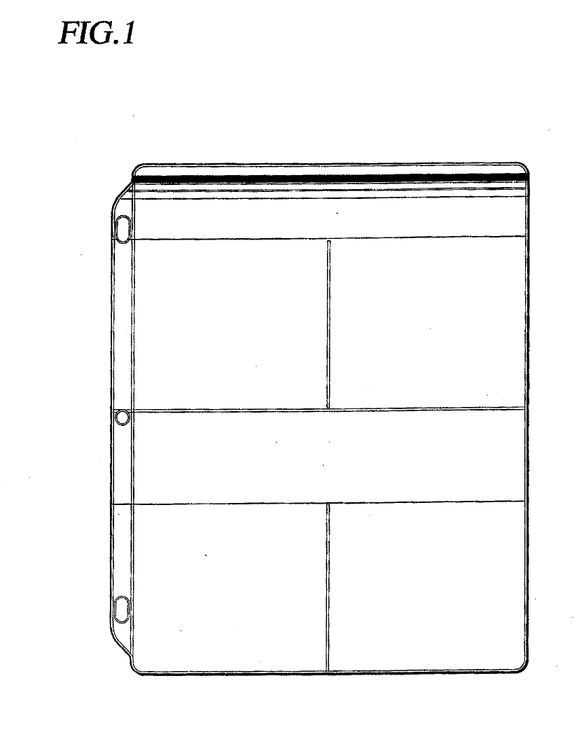

The functionality of the planner revolves around two-sided vinyl pouch pages, as seen in FIG. 1, which are used in several ways. A typical planner includes several vinyl pouch pages, with a center cavity and a “zip” closure, a business card holder, lead cards, printed calendar sheets, a set of four colored cards, and a set of cards containing the text with the months of the year.

The vinyl pouch pages, as seen in FIG. 1, are two sided and made of an “eight gauge duna” vinyl, or other suitable material. The vinyl pouch pages each have at least four slots to fit 3 by 5 inch lead cards on each side of the page. In almost all of the vinyl pouch pages in the present invention, a center cavity is present that can be sealed with a “zip” closure.

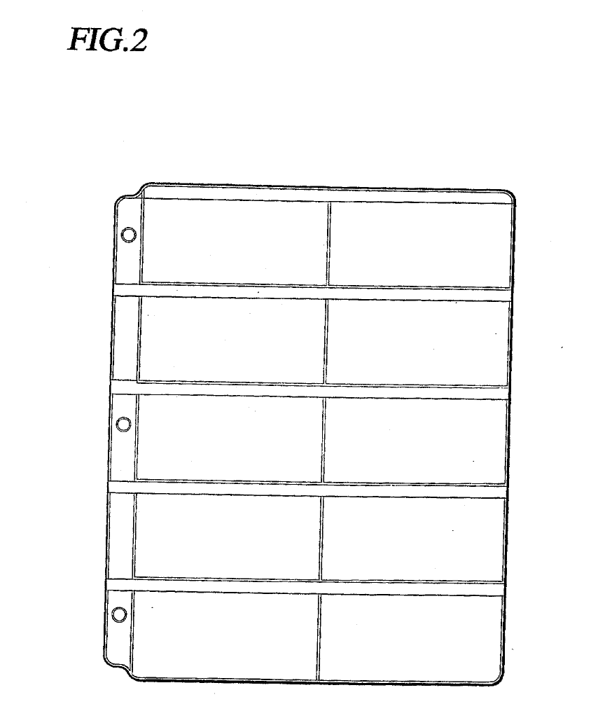

Referring to FIG. 2, a business card holder is shown. This holder is preferably made of vinyl, or other suitable material and is specifically designed to store a plurality of business cards.

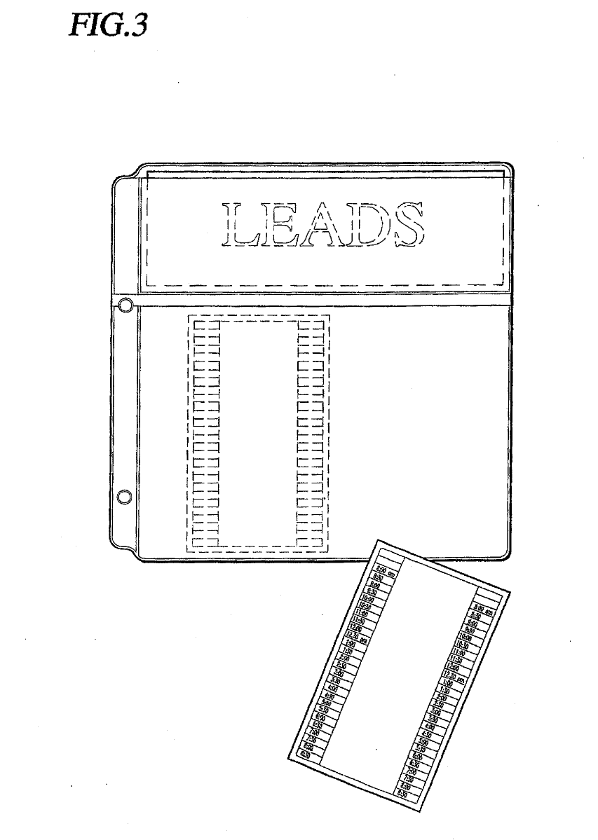

FIG. 3 shows lead cards being store in the front of a small two-sided pouch page. Lead cards contain two duplicate copies of the time of day down the left and right side of the card. The times of the day that are displayed can vary depending upon which shift is worked. The middle section of the lead card is blank.

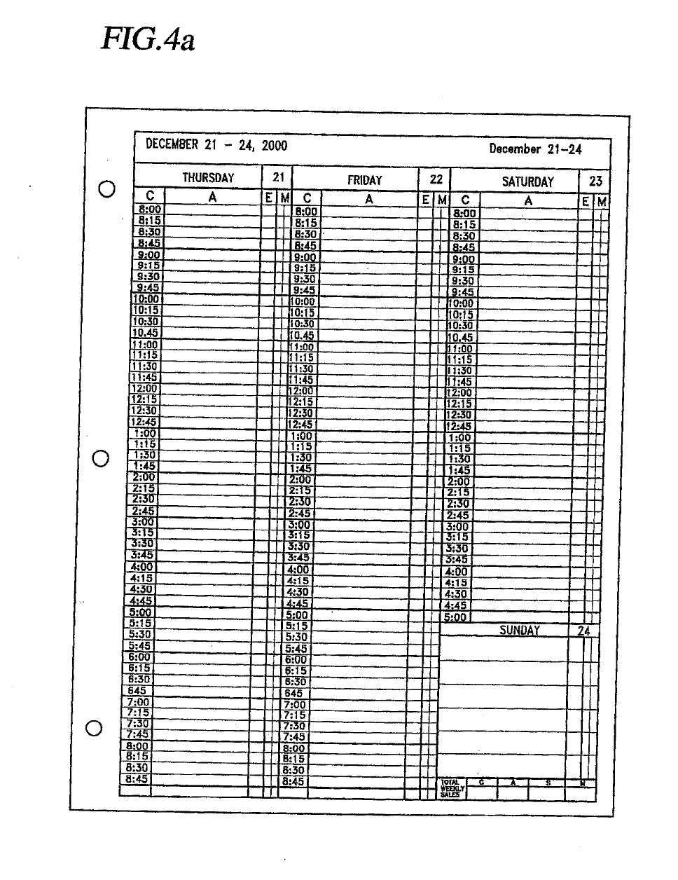

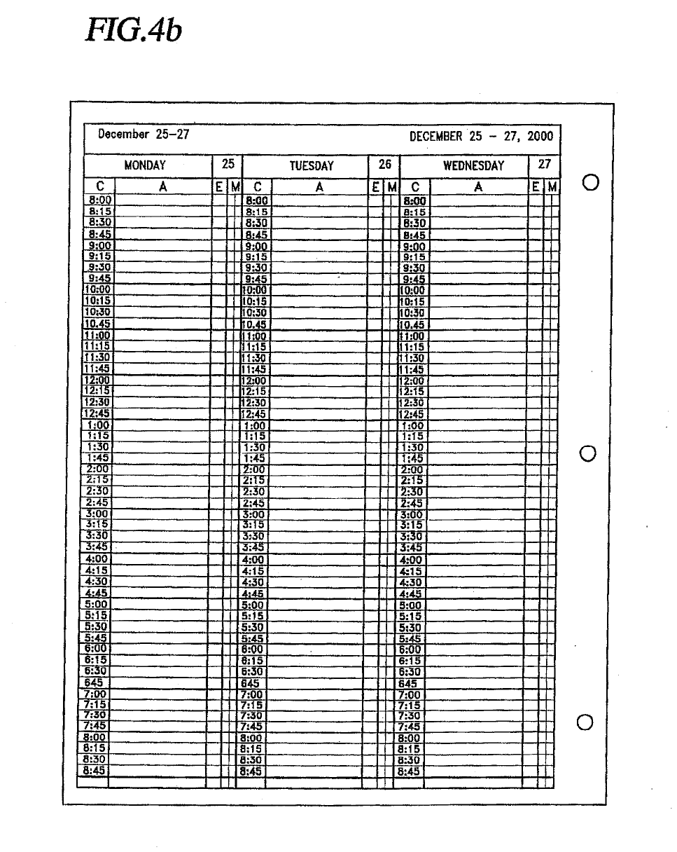

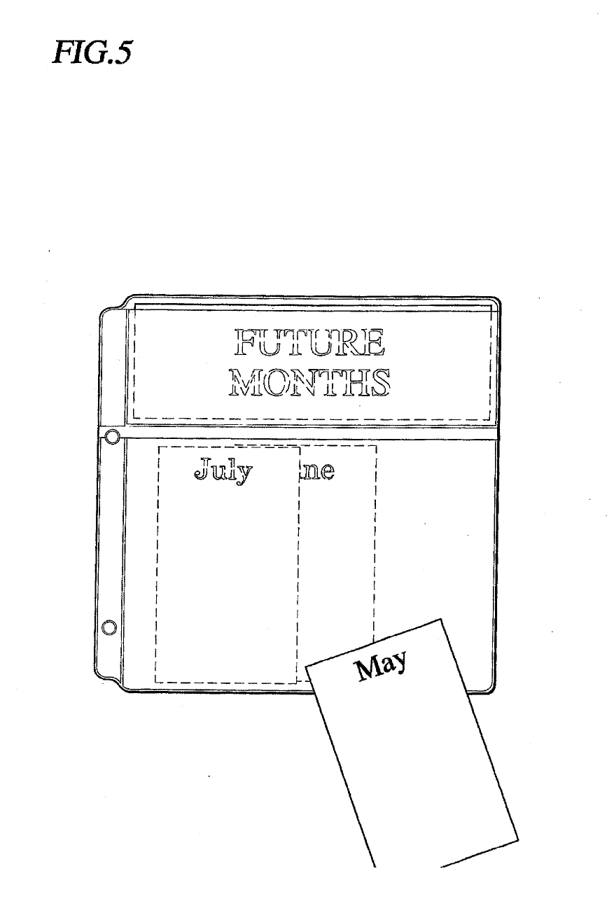

The printed calendar sheets are pages that would be typically found in paper planner currently in use today, with some changes made to the column headings. The calendar week has the days of the week printed at the top, along with the dates. Each printed calendar sheet contains either “Monday”, “Tuesday”, “Wednesday”, or “Thursday”, “Friday”, “Saturday”, and “Sunday”. Every day of the week, with the exception of Sunday, has four columns, each with a different heading, as shown in FIG. 4 (a & b). The first column shows the times of the day, which is an exact duplicate of the times printed on the lead cards (FIG. 3) and has the heading C (for calls). The second column has the heading A (for appointments). The third column has the heading E (for expenses). The fourth column has the heading M (for mileage). The meanings and uses of the headings corresponding to the columns are explained in greater detail later on in the detailed description.

FIG. 5 shows a set of cards containing the months of the year being stored in a small two-sided pouch page, where each month is printed on one card. The card is preferably 3 by 5 inches.

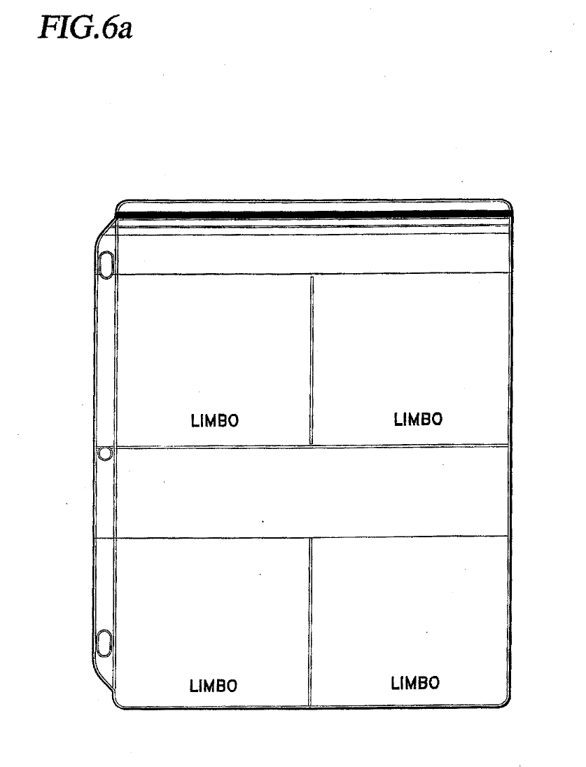

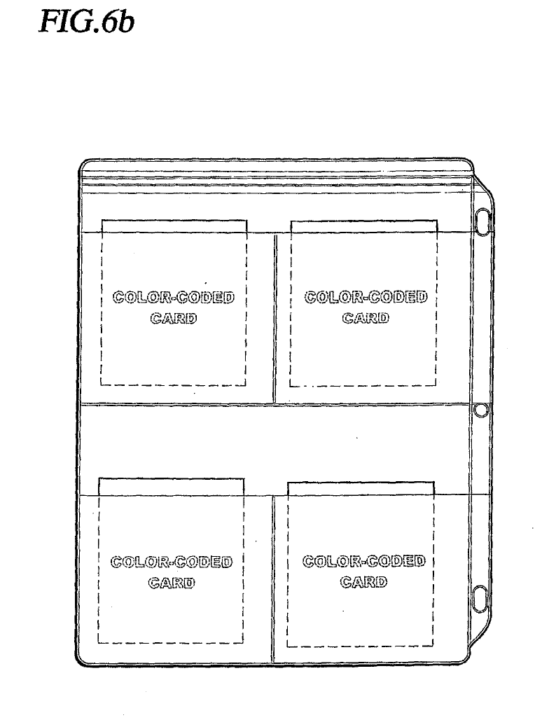

FIG. 6b shows an example of the color-coded cards in a vinyl pouch page. The color-coded cards are preferably 3 by 5 inches.

The function of the planner tool is to organize contacts or appointments, while being able to easily change elements of the contacts or appointments without having to rewrite information. The planner tool accomplishes this by utilizing a rotating envelope or pouch through time. The planner is an efficient tool for the business person, but it can be used in specific ways to obtain maximum efficiency. An example of the order of the pages present in the planner and the uses of these pages is given specifically for a sales person. However, the planner can be used by anyone in any profession.

The first page of the planning tool would be a vinyl pouch page, containing four pouches as shown in FIG. 6a, where the four pouches would be used for leads or prospects that are “in limbo” but not very “hot.” The back of the first pouch page, (FIG. 6b), would be used for filing future prospects or present weeks. Four different colored cards are inserted into the four pouches where each color represents a different week further along in the year. The color-coded weeks are associated with the current month in the year.

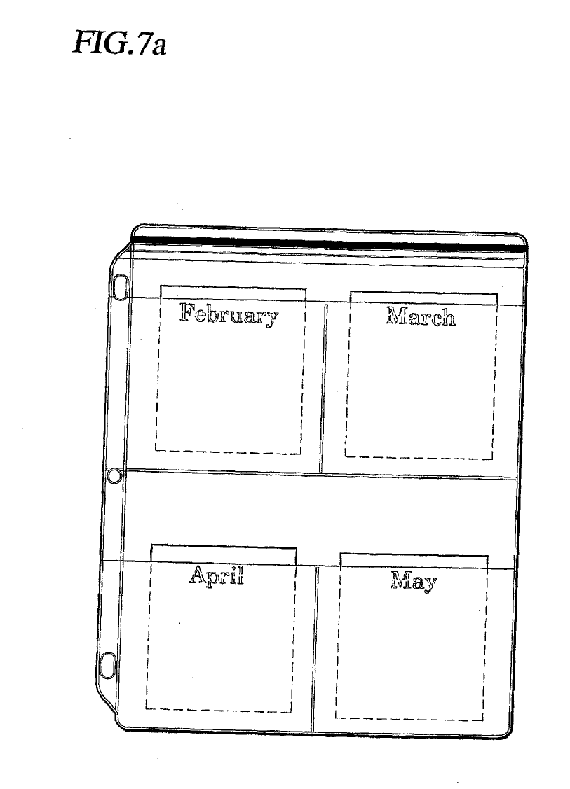

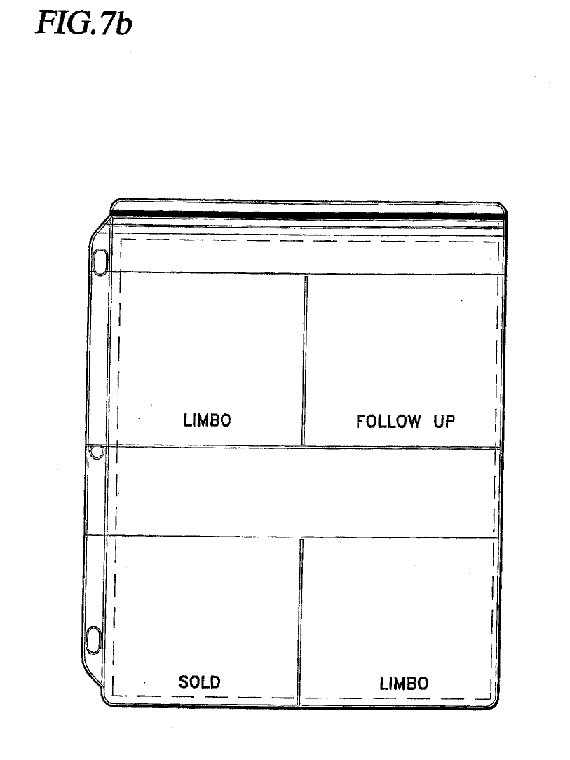

As shown in FIG. 7a, the next pouch page in the planner is used for the four “future” months of the year. For example, if the user was presently in the month of January, the four future months that would be present in the pouch page would be February, March, April, and May. When the month of February starts, the pouch that held the February card would be placed in the stack of rotating months, which are stored in the back of a small two sided pouch (e.g. FIG. 5). The June card is placed in the remaining slot previously occupied on the pouch page. As time goes on an old month is removed and a new month is always added. The cards used for this pouch page are shown in FIG. 3. The back of the second pouch page, as shown in FIG. 7b has “limbo”, “follow-up”, and “sold” printed on the pouches themselves. These titles are used for this example, and can be changed to fit the profession of the user.

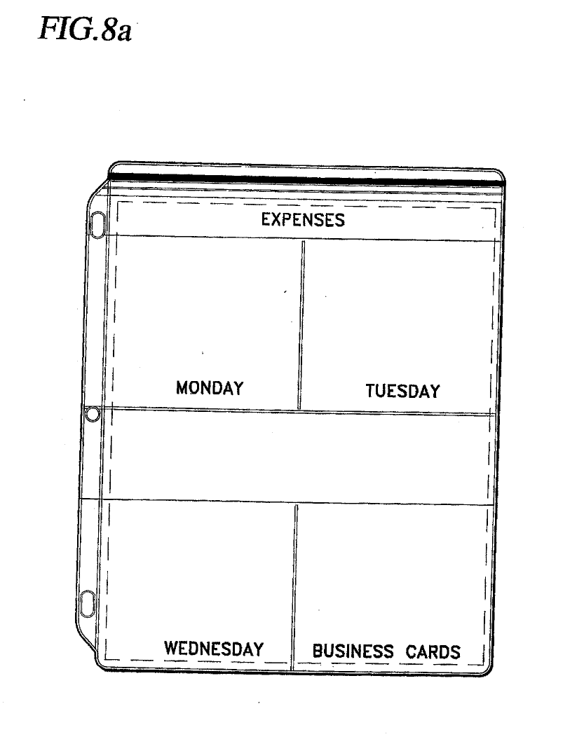

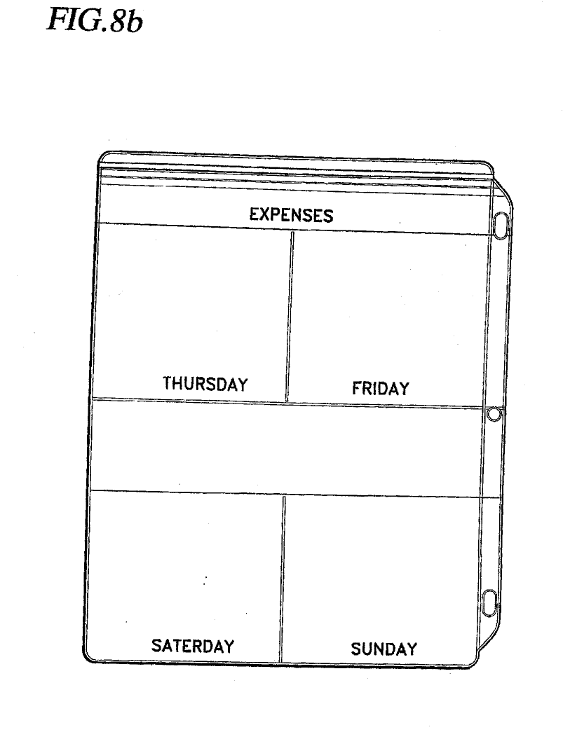

The next four pouch pages represent four “generic”, “floating”, or “rotating” weeks. As shown in FIG. 8a, each of the weekly pouches has four individual pouches on the front and four individual pouches on the back. Each individual pouch has a single label. The individual pouches all have different labels. The four front individual pouches are labeled “Monday”, “Tuesday”, “Wednesday”, or “business cards”. The four back individual pouches are labeled “Thursday”, “Friday”, “Saturday”, or “Sunday”, (FIG. 5b). The four weekly pouch pages all have different color paper within the center cavity. One has red, one green, one blue and one yellow, which coincide with the color coded weeks in FIG. 6b.

The weekly pouch pages run in series. The first weekly pouch page is inserted in the present week. As shown in FIG. 4a & b, the printed calendar sheets on either side of the pouch page are for each of the days on either side of the pouch page. Monday's pouch for Monday's printed page, Tuesday's for Tuesday's and so on. The next three pouch pages are to represent the corresponding, following three weeks. As time evolves, the pouch page that represents the current week, expires, the user then takes the pouch page for that week, and puts it in the center of the fourth week. This enables the user to always have 28 days worth of pouches in the future by which to place lead cards.

The printed calendar sheets as described above begin with “Thursday” through “Sunday” on the front side, as shown above and “Monday” through “Wednesday” on the back side, as shown above. On the top of every day you see the letters: C, A, E and M these letters stand for Call, Appointment, Expenses, and Mileage. The call column is for recording when a person asks to be called at a certain time, just circle the time in the C column. The appointment column is for recording a physical meeting. Simply circle the time on the page and write the customers name under the A column. This information is also written one time only on a lead card where the time is circled on the right side of the lead card.

The E on the top of every page is for recording expenses. To keep track of expenses, the number of the expense is written on the back of the receipt. The number will be whatever expense came last; for example if the user's first expense of the year will be #1. The user writes the number of the receipt in the E column across from the time and customer name with which it corresponds. All of the receipts go in the “zip” closure pouch for that week. Since the planning tool of the present invention works in groups of four weeks, the user can leave all the expenses for this week in the pouch until it comes through the planner again. At this time the user will have a months worth of receipts which are numbered, separated by week, and can be used as a written record of the time and place of expense.

The M on the top of the page is for recording mileage. There are two columns for each day. The user can record the mileage going to a business meeting in the first column, (longitudinally) and the return mileage in the next column. The user can draw a line under it and total the mileage for each day. There is a total section located at the bottom of Sunday. This is where the user can put the weekly mileage totals. There are also spaces for your calls, appointments, and sales totals.

The pouch pages are different colors for the following reason; if the user wishes to schedule a call back with a prospect for any particular week, this can be this week, or three future weeks, the user does not have to arbitrarily “pick a day” to perform that task. All four weeks are color-coded and the first pouch page in the very front of the book has four corresponding colored pouches. To make an appointment to call “this week”, the user simply finds the color of the pouch in the front of the book that corresponds to the week that they are in and places the card in this pouch. This allows the user to have an entire week worth of time in which to call, etc. . . without resigning themselves to any particular time during the day or the week. To make an appointment to call someone next week, or the week after that, or even the week after that, all that the user has to do is find the color in the front pouch page that corresponds to the color of that week and place the lead card in that pouch. If the user wants to schedule a call back but does not have a specific time to do so for a future month he/she can simply find the future month, as long as it is within the four months and place the card in that pouch. If the user does not have a time, day or week, to specifically call a prospect and they demand immediate attention, the user can put that prospect's card in the “limbo” file, which receives and requires daily attention and update. Once the user sells the prospect the good or service, the lead card goes in to the “sold” pouch. The “sold” pouch is used daily by the user to ensure that the customer's sale is going through properly. For example, the user would check to see if the payment went through, the product was delivered and/or installed on time, and that the customer is happy with the sale. After the customer has the product and it has been installed, then the card is placed in the “follow up” pouch, where the user can check up on the customer to make sure that they are happy with the product and attempt to obtain referrals for further sales.

The lead cards, as shown above, for the book, are printed to enable the user to schedule appointments to “see” and “call” people without writing the time down. The lead cards come with times of the day printed down both sides of the card. The time on the left is a “time to call” and the time on the right is a “time to see”. To make an appointment to call on a specific day, the user circles the time on the left hand side of the lead card, places the lead card in the pouch that represents the day to call, and circles the time on the printed calendar page under the day of the call. To schedule a “time to see” or an actual appointment with someone, the user does the same as the above, only using the right side of the lead card and actually writing the persons name in the slot next to the time on the printed calendar sheet, as shown above. The center of the lead cards is blank to allow for notes, or other pertinent information that is vital, such as how many units the customer is interested in, personal information of the customer, etc . . . , that helps make the sale.

The last page of the planner is the business card holder, as shown above, which holds business cards for all prospective clients that do not currently have appointments or need to be called at on a specific date and time.

An example of how a sales person would use the present invention to keep track of a client is as follows. A prospective client has left a number to call about the product that the salesperson sells. The prospect is called and asked a series of questions, of which the answers are jotted down in paraphrases in the center of the lead card as shown above. After talking to the prospective client, they tell you they want a call back next Tuesday at 8:00 am. The salesperson, using the present invention, circles 8:00 am on the left side of the lead card, puts the name of the client on the printed calendar sheets by circling the time under the C heading, as shown above, and puts the lead card into next Tuesday's pouch of the weekly vinyl pouch page. When the following Tuesday occurs, the salesperson checks the printed calendar sheets and see a call needs to made at 8:00 am and goes to the Tuesday pouch of the week and pulls out the card that has all of the necessary information to call the client. During the conversation with the client, they mention they are going to be gone for two weeks and want you to call them back then. Using the present invention, the salesperson looks and sees what color vinyl pouch page would be two weeks from now, as shown above. In this instance the pouch was “red”. The salesperson places the lead card in the limbo file located in the very front of the planner, as shown above. Two weeks go by and the week is now “red”. The lead card contains all the information to make the call and jog the memory as to what the client was interested in. The client makes an appointment for later that week on Thursday. The appointment time is circled on the right side of the card and written down under the A column in the printed calendar sheets, with the time circled. The lead card is then placed in the appropriate pouch regarding the day of the week the appointment is. At the appointment, the lead card is brought with the salesperson to review the necessary information that is important to the client and to write down anything else that is needed to complete the sale or if another call or appointment is needed. If a sale is made, the lead card goes into the sold portion pouch located on the back of the second vinyl pouch page as shown above. The salesperson continually follows up on the sale made in order to ensure that payment, delivery, and installation are completed on time. After the installation is complete, the lead card now goes into the follow up pouch located on the second vinyl pouch page as shown above. The salesperson never had to rewrite any information, nor arbitrarily pick a day two weeks in advance. All of the information was kept in one place and moved where necessary in terms of weeks or days.

### Alternatives

Small differences in printing and construction could easily produce a different planner that performs in the same way. The pouch pages can be made of a different material, such as paper, cardboard or plastic. The envelope in the center could be eliminated. Currently, this is used for the expense function of the book.

If the user only wanted one pouch for each week instead of having the option to place cards in all seven days of the week, four pouch pages with only one pouch, can be placed in the same position as the current weekly pouch pages (e.g. FIG. 8a). The user can go even further and use one side of the one pouch pages for a single day of the week. In this case, the user would be rotating through one week at a time.

If the printed pages and corresponding pouch pages instead of “Monday”, “Tuesday”, “Wednesday”, were “Monday”, “Tuesday”, “Wednesday”, and “Thursday”, leaving only “Friday”, “Saturday”, and “Sunday” on the reverse side. The book would perform exactly the same. If, instead of colors; numbers, letters, pictures or any of a number of different stimuli were used to label the “future weeks” and their corresponding pouches. The book and its lead cards can be sized to the desires of the consumer.

One thing that could be added to the planner to make it work better is computer software. Once a prospect is made into a customer it is good at that point to put them in a contact database. This is not to schedule appointments with them. Contact management software is easier to use than word processing programs for writing letters and keeping a database. The software could be designed to fit right along with the book and leave out all of the unnecessary functions and to have the software print lead cards.

Although the planner is geared primarily towards sales people, the organizational tools it provides could be used in many areas of professional and domestic life. For example, a teacher could use the Planning tool of the present invention to for scheduling homework assignments, exams, parent teacher conferences, etc.; a house wife could use it to schedule her children's appointments and activities and her personal appointments; or a chef could use it to document entrees to be served, past menus, and coming catered events. These are just a few examples of productive and efficient ways to use the planning tool of the present invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A planner tool comprising:
a) a plurality of pages each having at least one pouch for holding a card and holes appropriately spaced allowing for said pages to be inserted into a binder;
b) a plurality of lead cards having at least two sets of at least times of a day;
c) printed calendar sheets having at least:
i) holes appropriately spaced allowing for said sheets to be inserted into a binder; and
ii) printing on said sheets that includes a plurality of columns with headings and a duplicate of times listed on said plurality of lead cards.

2. The planner tool of claim 1, wherein said planner further consists of a set of cards containing text for a name of a month for every said month of a year.

3. The planner tool of claim 1, wherein said planner further consists of a set of colored-coded cards.

4. The cards of claims 3, wherein said set of colored-coded cards consist of at least four colors.

5. The planner tool of claim 1, wherein said plurality of pages contains a center cavity, sealed by a zip closure.

6. The page of claim 5, wherein said pouch contains at least four pouches located on outside sides of said page.

7. The planner tool of claim 1, wherein said lead cards have a blank center between a list of times of a day on both left and right sides of said lead cards.

8. The planner tool of claim 1, wherein said pages and calendar sheets are inserted into a binder.

9. The planner of claim 1, wherein said printed calendar sheets includes the dates for days of a week.

10. The printer calendar sheets of claim 9, wherein the dates can be printed on said sheets or written in by a user.

11. The planner of claim 1, wherein said printed calendar sheets contain c, a, e, and m headings, standing for call, appointment, expenses, and mileage respectively.

12. A kit that allows for tracking information and appointments comprising:
a) a plurality of pages each having at least one pouch for holding a card and holes appropriately spaced allowing for said pages to be inserted into a binder;
b) a plurality of lead cards having at least two sets of at least times of a day;
c) printed calendar sheets having at least:
i) holes appropriately spaced allowing for said sheets to be inserted into a binder; and
ii) printing on said sheets that includes a plurality of columns with headings and a duplicate of times listed on said plurality of lead cards.

13. A method for tracking information and appointments comprising the steps of:
a) getting a planner tool;
b) using said planner tool to:
i) keep track of expenses;
ii) making an appointment or an appointment to call; and
iii) keeping track of mileage

14. The method of claim 13, wherein said planner tool comprises:
a) a plurality of pages each having at least one pouch for holding a card and holes appropriately spaced allowing for said pages to be inserted into a binder;
b) a plurality of lead cards having at least two sets of at least times of a day;
c) printed calendar sheets having at least:
i) holes appropriately spaced allowing for said sheets to be inserted into a binder; and
ii) printing on said sheets that includes a plurality of columns with headings and a duplicate of times listed on said plurality of lead cards.

15. The method of claim 13, wherein keeping track of expenses comprises the steps of:
a) obtaining a receipt for an expense;
b) assigning and writing a number on said receipt;
c) recording said number of said receipt in a column headed by an e, across from a customer's name and time of appointment where said expense incurred on a printed calendar sheet; and
d) placing said receipt in a center cavity of a vinyl pouch page, which is sealed by a zip closure, of a corresponding week when said expense occurred.

16. The method of claim 13, wherein making an appointment or an appointment to call within a week, or later on in time comprises the steps of:
a) finding a color of a pouch in front of said planner that corresponds to said week with which a client wants said appointment or call;
b) circling a time on either side of a lead card corresponding to said appointment or call and on printed calendar sheets;
c) writing said appointment only on said printed calendar sheets under a column with a heading of a;
d) placing said lead card with all pertinent information in a vinyl pouch page corresponding to said color in front of said planner.

17. The method of claim 13, wherein keeping track of mileage comprises the steps of:
a) writing the number displayed by an odometer present in an automobile down on a calendar sheet under a first column under a heading of m before leaving to go to a destination;
b) writing the number displayed by an odometer present in said automobile down on said calendar sheet under a second column under a heading of m after getting back from said destination;
c) totaling mileage covered in a day to obtain daily mileage;
d) totaling said mileage calculated each day to obtain weekly mileage.
